(19) United States
(12) Patent Application Publication
(10) Pub. No.: US 2023/0024426 A1
(43) Pub. Date: Jan. 26, 2023

(54) SECONDARY BATTERY

(71) Applicant: MURATA MANUFACTURING CO., LTD., Kyoto (JP)

(72) Inventors: Masayuki IWAMA, Kyoto (JP); Hiroshi HORIUCHI, Kyoto (JP)

(21) Appl. No.: 17/954,756

(22) Filed: Sep. 28, 2022

Related U.S. Application Data
(63) Continuation of application No. PCT/JP2020/042560, filed on Nov. 16, 2020.

(30) Foreign Application Priority Data
Mar. 30, 2020 (JP) 2020-060357

(51) Int. Cl. H01M 10/0569; H01M 50/586; H01M 50/595; H01M 50/491

(52) U.S. Cl. CPC H01M 10/0569; H01M 50/586; H01M 50/595; H01M 50/491; H01M 10/0525

(57) ABSTRACT

A secondary battery includes a positive electrode, a negative electrode, an electrolytic solution, and an insulating member. The positive electrode includes a positive electrode current collector and a positive electrode active material layer. The negative electrode is opposed to the positive electrode. The electrolytic solution includes a chain carboxylic acid ester. The insulating member includes an adhesive layer including a rubber-based polymer compound. The positive electrode includes an exposed part in which the positive electrode current collector is exposed. The insulating member is adhered to the exposed part via the adhesive layer on a side opposed to the negative electrode.

### CROSS REFERENCE TO RELATED APPLICATIONS

The present application is a continuation of PCT application no. PCT/JP2020/042560, filed on Nov. 16, 2020, which claims priority to Japanese patent application no. JP2020-060357, filed on Mar. 30, 2020, the entire contents of which are herein incorporated by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution.

A configuration of the secondary battery influences a battery characteristic and has therefore been considered in various ways. Specifically, in order to prevent a short circuit from spreading over a wider range due to a thermal shrinkage of a separator, the separator is provided with a thermal-shrinkage-preventing layer at a portion opposed to a lead.

### SUMMARY

The present application relates to a secondary battery.

Consideration has been given in various ways to improve a battery characteristic of a secondary battery; however, a cyclability characteristic, a swelling characteristic, and safety of the secondary battery each still remain insufficient. Accordingly, there is still room for improvement in terms of those characteristics.

The present technology has been made in view of such an issue, and thus relates to providing a secondary battery that is able to achieve a superior cyclability characteristic, a superior swelling characteristic, and superior safety according to an embodiment.

A secondary battery according to an embodiment includes a positive electrode, a negative electrode, an electrolytic solution, and an insulating member. The positive electrode includes a positive electrode current collector and a positive electrode active material layer. The negative electrode is opposed to the positive electrode. The electrolytic solution includes a chain carboxylic acid ester. The insulating member includes an adhesive layer including a rubber-based polymer compound. The positive electrode includes an exposed part in which the positive electrode current collector is exposed. The insulating member is adhered to the exposed part via the adhesive layer on a side opposed to the negative electrode.

According to the secondary battery of an embodiment, the electrolytic solution includes the chain carboxylic acid ester, the insulating member includes the adhesive layer including the rubber-based polymer compound, and the insulating member is adhered to the exposed part of the positive electrode via the adhesive layer on the side opposed to the negative electrode. Accordingly, it is possible to achieve a superior cyclability characteristic, a superior swelling characteristic, and superior safety.

Note that effects of the present technology are not limited to those described herein and may include any of a series of suitable effects.

### BRIEF DESCRIPTION OF THE FIGURES

FIG. 1 is a perspective view of a configuration of a secondary battery according to an embodiment of the present technology.

FIG. 2 is a plan view of a configuration of a battery device illustrated in FIG. 1.

FIG. 3 is a sectional view of the configuration of the battery device taken along line A-A illustrated in FIG. 2.

FIG. 4 is a schematic sectional view of the configuration of the battery device illustrated in FIG. 1.

FIG. 5 is a schematic view of a winding state of the battery device illustrated in FIG. 1.

FIG. 6 is an enlarged sectional view of the configuration of the battery device illustrated in FIG. 1.

FIG. 7 is an enlarged sectional view of a configuration of a separator illustrated in FIG. 6.

FIG. 8 is an enlarged sectional view of a configuration of a main part of the battery device illustrated in FIG. 1.

FIG. 9 is a sectional view of a configuration of a secondary battery (a battery device).

FIG. 10 is a block diagram illustrating a configuration of an application example of the secondary battery.

### DETAILED DESCRIPTION

The present application is described below in further detail including with reference to the drawings according to an embodiment.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution. In the secondary battery, to prevent unintentional precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

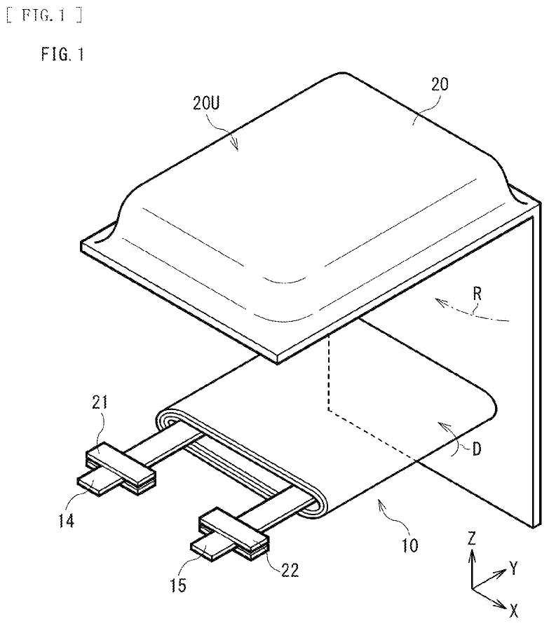

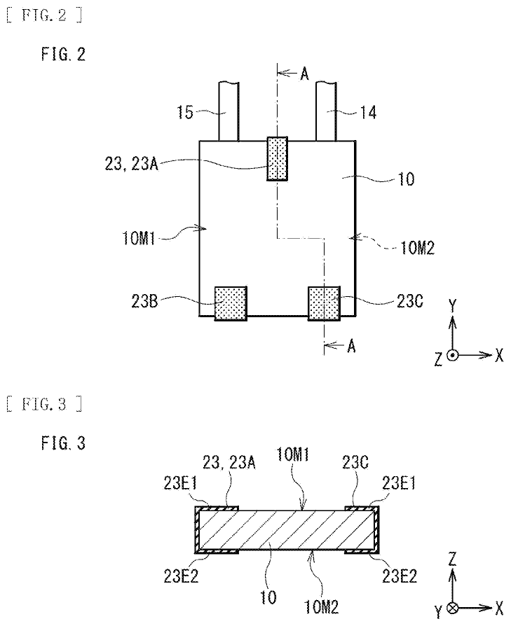

FIG. 1 illustrates a perspective configuration of the secondary battery. FIG. 2 illustrates a planar configuration of a battery device 10 illustrated in FIG. 1. FIG. 3 illustrates a sectional configuration of the battery device 10 taken along line A-A illustrated in FIG. 2. Note that FIG. 1 illustrates a state in which the battery device 10 and an outer package film 20 are separated away from each other.

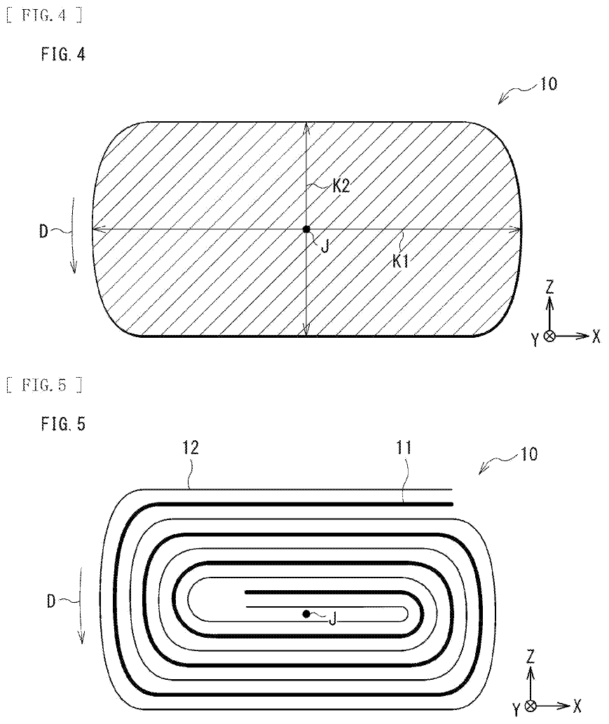

FIG. 4 schematically illustrates the sectional configuration of the battery device 10 illustrated in FIG. 1. FIG. 5 schematically illustrates a winding state of the battery device 10 illustrated in FIG. 1. Note that FIG. 4 illustrates a section of the battery device 10 intersecting a winding axis J extending in a Y-axis direction. For simplifying the illustration, FIG. 5 illustrates a positive electrode 11 in a thick line and a negative electrode 12 in a thin line.

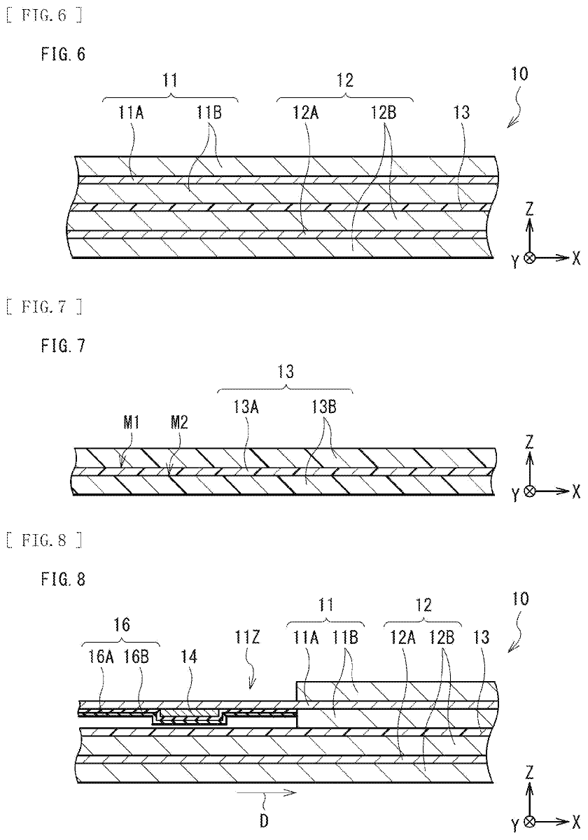

FIG. 6 illustrates an enlarged sectional configuration of the battery device 10 illustrated in FIG. 1. FIG. 7 illustrates an enlarged sectional configuration of a separator 13 illustrated in FIG. 6. Note that FIG. 6 illustrates only respective portions of the positive electrode 11, the negative electrode 12, and the separator 13, and FIG. 7 illustrates only a portion of the separator 13.

FIG. 8 illustrates an enlarged sectional configuration of a main part of the battery device 10 illustrated in FIG. 1. Note that FIG. 8 illustrates a portion near a location where an insulating tape 16 is provided.

As illustrated in FIGS. 1 to 8, the secondary battery includes the battery device 10, the outer package film 20, a positive electrode lead 14, a negative electrode lead 15, the insulating tape 16, and a fixing tape 23. The battery device 10 is contained inside the outer package film 20. The positive electrode lead 14 and the negative electrode lead 15 are led out in a common direction from inside to outside the outer package film 20.

The secondary battery described here is a secondary battery of a laminated-film type. The secondary battery of the laminated-film type includes an outer package member having flexibility or softness, that is, the outer package film 20, as an outer package member to contain the battery device 10.

The outer package film 20 is a single film-shaped member and is foldable in a direction of an arrow R (a dash-dotted line), as illustrated in FIG. 1. The outer package film 20 is a flexible outer package member containing the battery device 10 as described above. The outer package film 20 thus contains the positive electrode 11, the negative electrode 12, an electrolytic solution, and the insulating tape 16. The outer package film 20 has a depression part 20U to place the battery device 10 therein. The depression part 20U is a so-called deep drawn part.

Specifically, the outer package film 20 is a three-layer laminated film including a fusion-bonding layer, a metal layer, and a surface protective layer that are stacked in this order from an inner side. When the outer package film 20 is in a folded state, outer edges of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers. In other words, the outer package film 20 is not limited to a laminated film, and may be a single-layer film.

A sealing film 21 is interposed between the outer package film 20 and the positive electrode lead 14. A sealing film 22 is interposed between the outer package film 20 and the negative electrode lead 15. The sealing films 21 and 22 are members that each prevent unintentional entry of, for example, outside air into the outer package film 20, and each include one or more of polymer compounds, including polyolefin, that have adherence to both the positive electrode lead 14 and the negative electrode lead 15. Examples of the polyolefin include polyethylene, polypropylene, modified polyethylene, and modified polypropylene. Note that the sealing film 21, the sealing film 22, or both may be omitted.

The fixing tape 23 is a fixing member attached to the battery device 10 in order to maintain a three-dimensional shape (a shaped state) of the battery device 10. As illustrated in FIGS. 2 and 3, the fixing tape 23 extends from one end part (a top surface 10M1) to another end part (a bottom surface 10M2) of the battery device 10 in a direction intersecting a major axis K1 (FIG. 4) to be described later, and is fixed to each of the top surface 10M1 and the bottom surface 10M2. In FIG. 2, the fixing tape 23 is shaded.

Specifically, as will be described later, a section of the battery device 10 has an elongated shape defined by the major axis K1 and a minor axis K2. The battery device 10 having the elongated sectional shape is fabricated by winding the positive electrode 11 and the negative electrode 12 with the separator 13 interposed therebetween to thereby fabricate a wound body, and thereafter pressing (shaping) the wound body to have the elongated sectional shape. The wound body described here has a configuration similar to that of the battery device 10 except that the positive electrode 11, the negative electrode 12, and the separator 13 are each unimpregnated with the electrolytic solution.

The fixing tape 23 is a band-shaped adhesive member extending in a direction in which the wound body is pressed, that is, the direction intersecting the major axis K1. The direction of extension of the fixing tape 23 is not particularly limited as long as the direction intersects the major axis K1, and may be a direction along the minor axis K2, that is, a Z-axis direction, or may be a direction inclined with respect to the minor axis K2. Here, the fixing tape 23 extends in the direction along the minor axis K2.

In addition, the fixing tape 23 has one end part (a top end part 23E1) and another end part (a bottom end part 23E2). Accordingly, in the fixing tape 23, the top end part 23E1 is adhered to the top surface 10M1 of the battery device 10 and the bottom end part 23E2 is adhered to the bottom surface 10M2 of the battery device 10. The battery device 10 is thus interposed between the top end part 23E1 and the bottom end part 23E2 in the direction intersecting the major axis K1. Accordingly, the fixing tape 23 has a function of helping to prevent the battery device 10 from deforming in a direction opposite to the direction of pressing (that is, from restoring the original shape) due to elastic deformation. In other words, the fixing tape 23 has a function of maintaining the three-dimensional shape (the shaped state) of the battery device 10.

The fixing tape 23 is not particularly limited in configuration as long as the fixing tape 23 is a tape-shaped member having adhesiveness. In addition, the fixing tape 23 is not particularly limited in number or location as long as the fixing tape 23 is able to maintain the three-dimensional shape of the battery device 10.

Here, as illustrated in FIG. 2, the secondary battery includes three fixing tapes 23 (23A, 23B, and 23C). In a direction along the winding axis J, i.e., in the Y-axis direction, the fixing tape 23A is disposed on a side closer to the positive electrode lead 14 and the negative electrode lead 15, whereas the fixing tapes 23B and 23C are disposed on a side farther from the positive electrode lead 14 and the negative electrode lead 15. The fixing tapes 23B and 23C are separated from each other with a spacing therebetween.

As illustrated in FIGS. 1 to 7, the battery device 10 includes the positive electrode 11, the negative electrode 12, the separator 13, and the electrolytic solution which is a liquid electrolyte. The positive electrode 11, the negative electrode 12, and the separator 13 are each impregnated with the electrolytic solution. Note that FIGS. 6 and 7 omit the illustration of the electrolytic solution.

As illustrated in FIGS. 1 and 4 to 6, the battery device 10 is a structure in which the positive electrode 11 and the negative electrode 12 are wound in a winding direction D with the separator 13 interposed therebetween, and is thus a so-called wound electrode body. Here, the battery device 10 which is the wound electrode body is provided by stacking the positive electrode 11 and the negative electrode 12 on each other with the separator 13 interposed therebetween, and winding the stack of the positive electrode 11, the negative electrode 12, and the separator 13 in the winding direction D about the winding axis J. In other words, the positive electrode 11 and the negative electrode 12 are wound together with the separator 13 while being opposed to each other with the separator 13 interposed therebetween. Note that FIG. 5 omits the illustration of the separator 13.

As illustrated in FIG. 4, in a section intersecting the winding axis J, that is, in a section along an XZ plane, the battery device 10 has an elongated shape defined by the major axis K1 and the minor axis K2, and more specifically, has an elongated, substantially oval shape. The major axis K1 is an axis extending in an X-axis direction and having a relatively large length, that is, a horizontal axis. The minor axis K2 is an axis extending in the Z-axis direction intersecting the X-axis direction and having a relatively small length, that is, a vertical axis.

As illustrated in FIG. 6, the positive electrode 11 includes a positive electrode current collector 11A, and two positive electrode active material layers 11B provided on respective opposite sides of the positive electrode current collector 11A. Note that the positive electrode active material layer 11B may be provided only on one of the opposite sides of the positive electrode current collector 11A.

The positive electrode current collector 11A includes one or more of electrically conductive materials including, without limitation, a metal material. Examples of the metal material include aluminum, nickel, and stainless steel. The positive electrode active material layer 11B includes one or more of positive electrode active materials into which lithium is insertable and from which lithium is extractable. Note that the positive electrode active material layer 11B may further include, for example, a positive electrode binder and a positive electrode conductor.

Although not particularly limited in kind, the positive electrode active material is specifically a lithium-containing compound, such as a lithium-containing transition metal compound. The lithium-containing transition metal compound includes lithium and one or more transition metal elements, and may further include one or more other elements. The other elements may be any elements other than transition metal elements, and are not particularly limited in kind. Specifically, however, the other elements are elements belonging to groups 2 to 15 in the long period periodic table of elements. The lithium-containing transition metal compound is not particularly limited in kind, and may specifically be any of, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO4, LiMnPO₄, LiFe_{0.5}Mn_{0.5}PO₄, and LiFe_{0.3}Mn_{0.7}PO₄.

Here, the positive electrode active material layer 11B is provided only partially on the positive electrode current collector 11A in the winding direction D. Accordingly, at an end part of the positive electrode 11 on an inner side of winding, the positive electrode current collector 11A is not covered with the positive electrode active material layer 11B and is thus exposed; and at an end part of the positive electrode 11 on an outer side of the winding, the positive electrode current collector 11A is not covered with the positive electrode active material layer 11B and is thus exposed.

A description will be given later as to a detailed configuration of the positive electrode 11 in which the positive electrode current collector 11A is exposed at the end part on the inner side of the winding (see FIG. 8).

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 12 is opposed to the positive electrode 11, as described above. As illustrated in FIG. 6, the negative electrode 12 includes a negative electrode current collector 12A, and two negative electrode active material layers 12B provided on respective opposite sides of the negative electrode current collector 12A. Note that the negative electrode active material layer 12B may be provided only on one of the opposite sides of the negative electrode current collector 12A.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable. Note that the negative electrode active material layer 12B may further include, for example, a negative electrode binder and a negative electrode conductor. Details of the negative electrode binder are similar to those of the positive electrode binder. Details of the negative electrode conductor are similar to those of the positive electrode conductor.

The negative electrode active material is not particularly limited in kind. Specific examples of the negative electrode active material include a carbon material and a metal-based material. Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. Examples of such metal elements and metalloid elements include silicon and tin. The metal-based material may be a simple substance, an alloy, a compound, a mixture of two or more thereof, or a material including two or more phases thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that “v” of SiOᵥ may satisfy 0.2<v<1.4.

A method of forming the negative electrode active material layer 12B is not particularly limited, and specifically, one or more methods are selected from among a coating method, a vapor-phase method, a liquid-phase method, a thermal spraying method, a firing (sintering) method, and other methods.

Here, the negative electrode active material layer 12B is provided only partially on the negative electrode current collector 12A in the winding direction D. Accordingly, at an end part of the negative electrode 12 on the inner side of the winding, the negative electrode current collector 12A is not covered with the negative electrode active material layer 12B and is thus exposed; and at an end part of the negative electrode 12 on the outer side of the winding, the negative electrode current collector 12A is not covered with the negative electrode active material layer 12B and is thus exposed.

The separator 13 is an insulating porous film interposed between the positive electrode 11 and the negative electrode 12 as illustrated in FIG. 6, and allows lithium ions to pass therethrough while preventing a contact between the positive electrode 11 and the negative electrode 12.

Here, the separator 13 has a multilayer structure including a polymer compound layer 13B to be described later. Specifically, as illustrated in FIG. 7, the separator 13 having the multilayer structure includes a porous layer 13A, and two polymer compound layers 13B provided respectively on two opposed surfaces of the porous layer 13A. A reason for this is that adherence of the separator 13 to each of the positive electrode 11 and the negative electrode 12 is thereby improved to suppress the occurrence of positional displacement of the battery device 10. This prevents the secondary battery from easily swelling even if, for example, a decomposition reaction of the electrolytic solution occurs. Note that the polymer compound layer 13B may be provided only on one of the two opposed surfaces of the porous layer 13A.

The porous layer 13A is interposed between the positive electrode 11 and the negative electrode 12, and has the two opposed surfaces, that is, opposed surfaces M1 and M2. The opposed surface M1 is a surface of the porous layer 13A on a side opposed to the positive electrode 11. The opposed surface M2 is a surface of the porous layer 13A on a side opposed to the negative electrode 12. The porous layer 13A includes one or more of polymer compounds including, without limitation, polytetrafluoroethylene, polypropylene, and polyethylene. Note that the porous layer 13A may be single-layered or multilayered.

The polymer compound layer 13B is provided on each of the two opposed surfaces of the porous layer 13A, and is thus provided on each of the opposed surfaces M1 and M2. The polymer compound layer 13B includes a polymer compound and inorganic particles. A reason for this is that the inorganic particles dissipate heat upon heat generation by the secondary battery, and this improves heat resistance and safety of the secondary battery. Note that the polymer compound layer 13B may be single-layered or multilayered.

The polymer compound includes one or more of polymer compounds including, without limitation, polyvinylidene difluoride. A reason for this is that superior physical strength and electrochemical stability are achievable. The inorganic particles include one or more of inorganic materials including, without limitation, aluminum oxide (alumina), aluminum nitride, boehmite, silicon oxide (silica), titanium oxide (titania), magnesium oxide (magnesia), and zirconium oxide (zirconia).

Here, the porous layer 13A and the polymer compound layer 13B each constitute a portion (one component) of the separator 13 having the multilayer structure. Accordingly, the porous layer 13A and the polymer compound layer 13B are integral with each other.

The electrolytic solution includes a solvent and an electrolyte salt.

The solvent includes one or more of non-aqueous solvents (organic solvents). The electrolytic solution including a non-aqueous solvent is a so-called non-aqueous electrolytic solution.

Specifically, the solvent includes one or more of chain carboxylic acid esters. A reason for this is that such a solvent helps to prevent the discharge capacity from easily decreasing even upon repeated charging and discharging.

The chain carboxylic acid ester is not particularly limited in kind. Specific examples of the chain carboxylic acid ester include methyl acetate, ethyl acetate, ethyl trimethyl acetate, methyl propionate, ethyl propionate, propyl propionate, methyl buryrate, and ethyl butyrate.

Although not particularly limited, a content of the chain carboxylic acid ester in the solvent is preferably within a range from 20 wt % to 60 wt % both inclusive, in particular. A reason for this is that such a range helps to prevent the insulating tape 16 from easily peeling away from an exposed part 11Z to be described later, and helps to sufficiently prevent the discharge capacity from easily decreasing even upon repeated charging and discharging.

In addition, the solvent may include one or more of other solvents. Examples of the other solvent include esters and ethers. More specific examples of the other solvent include a carbonic-acid-ester-based compound and a lactone-based compound. Examples of the carbonic-acid-ester-based compound include a cyclic carbonic acid ester and a chain carbonic acid ester. Examples of the cyclic carbonic acid ester include ethylene carbonate and propylene carbonate. Examples of the chain carbonic acid ester include dimethyl carbonate, diethyl carbonate, and methyl ethyl carbonate. Examples of the lactone-based compound include γ-butyrolactone and γ-valerolactone. Examples of the ethers other than the lactone-based compounds described above include 1,2-dimethoxyethane, tetrahydrofuran, 1,3-dioxolane, and 1,4-dioxane.

Further examples of the other solvent include an unsaturated cyclic carbonic acid ester, a halogenated carbonic acid ester, a sulfonic acid ester, a phosphoric acid ester, an acid anhydride, a nitrile compound, and an isocyanate compound. A reason for this is that chemical stability of the electrolytic solution improves.

Specifically, examples of the unsaturated cyclic carbonic acid ester include vinylene carbonate, vinylethylene carbonate, and methylene ethylene carbonate. Example of the halogenated carbonic acid ester include monofluoroethylene carbonate and difluoroethylene carbonate. Examples of the sulfonic acid ester include 1,3-propane sultone and 1,3-propene sultone. Examples of the phosphoric acid ester include trimethyl phosphate. Examples of the acid anhydride include a cyclic carboxylic acid anhydride, a cyclic disulfonic acid anhydride, and a cyclic carboxylic acid sulfonic acid anhydride. Examples of the cyclic carboxylic acid anhydride include succinic anhydride, glutaric anhydride, and maleic anhydride. Examples of the cyclic disulfonic acid anhydride include ethane disulfonic anhydride and propane disulfonic anhydride. Examples of the cyclic carboxylic acid sulfonic acid anhydride include sulfobenzoic anhydride, sulfopropionic anhydride, and sulfobutyric anhydride. Examples of the nitrile compound include acetonitrile, acrylonitrile, malononitrile, succinonitrile, glutaronitrile, adiponitrile, sebaconitrile, and phthalonitrile. Examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃S₀₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), and lithium bis(oxalato)borate (LiB(C₂O₄)₂). Although not particularly limited, a content of the electrolyte salt is specifically within a range from 0.3 mol/kg to 3.0 mol/kg both inclusive with respect to the solvent. A reason for this is that a high ionic conductivity is obtainable.

The positive electrode lead 14 is a positive electrode terminal coupled to the positive electrode 11, and includes one or more of electrically conductive materials including, without limitation, aluminum. More specifically, the positive electrode lead 14 is coupled to the positive electrode current collector 11A that is exposed by not being covered with the positive electrode active material layer 11B. The positive electrode lead 14 has a thin plate shape or a meshed shape, for example.

The negative electrode lead 15 is a negative electrode terminal coupled to the negative electrode 12, and includes one or more of electrically conductive materials including, without limitation, copper, nickel, and stainless steel. The negative electrode lead 15 is coupled to the negative electrode current collector 12A that is exposed by not being covered with the negative electrode active material layer 12B. The negative electrode lead 15 has a shape similar to that of the positive electrode lead 14.

Here, the positive electrode lead 14 is coupled to the positive electrode current collector 11A (the exposed part 11Z to be described later) at the end part of the positive electrode 11 on the inner side of the winding in the winding direction D. Further, the negative electrode lead 15 is coupled to the negative electrode current collector 12A at the end part of the negative electrode 12 on the inner side of the winding in the winding direction D. Note that the positive electrode lead 14 and the negative electrode lead 15 are disposed not to overlap each other.

The number of the positive electrode leads 14 and the number of the negative electrode leads 15 are not particularly limited, and may each be one, or may each be two or more. In this case, if the number of the positive electrode leads 14 and the number of the negative electrodes leads 15 are each two or more, in particular, the secondary battery decreases in electrical resistance. FIGS. 1 and 2 illustrate a case where the number of the positive electrode leads 14 is one and the number of the negative electrode leads 15 is one.

The insulating tape 16 is an insulating member that prevents a short circuit between the positive electrode 11 and the negative electrode 12 and prevents unintentional precipitation of lithium during charging and discharging. The insulating tape 16 has adhesiveness, and is provided in the positive electrode 11.

Specifically, as illustrated in FIG. 8, the positive electrode 11 includes the exposed part 11Z. Here, the exposed part 11Z is located at the end part of the positive electrode 11 in the winding direction D. The exposed part 11Z is a portion of the positive electrode 11, and more specifically, a portion in which the positive electrode current collector 11A is opposed to the negative electrode 12 (here, the negative electrode active material layer 12B) and in which the positive electrode current collector 11A is not covered with the positive electrode active material layer 11B and is thus exposed.

More specifically, in the winding direction D, a range of formation of the negative electrode active material layer 12B in the negative electrode 12 is more extensive than a range of formation of the positive electrode active material layer 11B in the positive electrode 11. Accordingly, at the end part of the positive electrode 11 in the winding direction D, that is, at the exposed part 11Z, the positive electrode current collector 11A is not covered with the positive electrode active material layer 11B and is thus exposed, and the positive electrode current collector 11A thus exposed is opposed to the negative electrode active material layer 12B with the separator 13 interposed therebetween.

Here, the exposed part 11Z is located at the end part of the positive electrode 11 on the inner side of the winding in the winding direction D, and therefore the positive electrode 11 includes the exposed part 11Z at the end part on the inner side of the winding. Further, the positive electrode lead 14 is coupled to the exposed part 11Z, thus being electrically coupled to the positive electrode 11 (the positive electrode current collector 11A).

In this case, the insulating tape 16 is provided on the exposed part 11Z. More specifically, the insulating tape 16 is adhered to a surface of the exposed part 11Z on a side opposed to the negative electrode active material layer 12B.

The insulating tape 16 includes an adhesive layer 16B. More specifically, the insulating tape 16 includes a base material layer 16A having an insulating property, and the adhesive layer 16B provided on a surface of the base material layer 16A. Accordingly, the insulating tape 16 is adhered to the exposed part 11Z via the adhesive layer 16B.

The base material layer 16A includes one or more of insulating polymer compounds. Examples of such polymer compounds include polyethylene terephthalate (PET) and polyethylene (PE).

The adhesive layer 16B includes one or more of rubber-based polymer compounds. The “rubber-based polymer compound” refers to a so-called rubber-based adhesive, that is, an adhesive that includes a rubber-elastic polymer as a base material. Examples of the rubber-elastic polymer include a natural rubber and a synthetic rubber. The “rubber-based polymer compound” also includes an adhesive into which a tackifier, for example, has been introduced. Specific examples of the rubber-based polymer compound include an isoprene rubber, a butadiene rubber, a styrene-butadiene rubber, a chloroprene rubber, a nitrile rubber, a polyisobutylene rubber, chlorosulfonated polyethylene, an acrylic rubber, a fluorine rubber, an epichlorohydrin rubber, a urethane rubber, and a silicone rubber.

A reason why the adhesive layer 16B includes the rubber-based polymer compound is that this prevents the adhesive layer 16B from being easily swollen with the chain carboxylic acid ester in the electrolytic solution (the solvent), thus preventing the chain carboxylic acid ester from easily infiltrating into between the base material layer 16A and the exposed part 11Z. Accordingly, an adhesion strength of the adhesive layer 16B to the exposed part 11Z is prevented from easily decreasing, and the insulating tape 16 is thus prevented from easily peeling away from the exposed part 11Z. Consequently, even if the solvent includes the chain carboxylic acid ester, a short circuit between the positive electrode 11 and the negative electrode 12 is prevented from easily occurring, and precipitation of lithium is suppressed during charging and discharging.

A range of provision of the insulating tape 16 on the exposed part 11Z is not particularly limited. Accordingly, the range of provision of the insulating tape 16 may be over a portion of the surface of the exposed part 11Z, or may be over the entire surface of the exposed part 11Z. Needless to say, multiple insulating tapes 16 separated from each other may be adhered to the surface of the exposed part 11Z. FIG. 8 illustrates a case where the insulating tape 16 is adhered to the entire surface of the exposed part 11Z.

Although not particularly limited, the adhesion strength of the insulating tape 16 to the exposed part 11Z preferably falls within a range from 1 mN/mm² to 15 mN/mm² both inclusive, in particular. A reason for this is that such a range secures the adhesiveness of the insulating tape 16 to the exposed part 11Z and thus sufficiently prevents the insulating tape 16 from easily peeling away. The adhesion strength is measured by means of a peel tester for 180-degree peeling, such as Tensilon, a universal testing instrument. Note that the adhesive layer 16B may be set to a desired thickness depending on the adhesion strength described above.

Here, as illustrated in FIG. 8, the positive electrode lead 14 is coupled to the exposed part 11Z, and the insulating tape 16 adhered to the exposed part 11Z thus covers the positive electrode lead 14. A reason for this is that this allows a state of coupling of the positive electrode lead 14 to the positive electrode current collector 11A to be protected by the insulating tape 16, thus making it easier to maintain the state of coupling of the positive electrode lead 14 to the positive electrode current collector 11A. Accordingly, even if the secondary battery undergoes, for example, a shock upon falling, the positive electrode lead 14 is prevented from easily becoming detached from the positive electrode current collector 11A.

Further, as illustrated in FIGS. 7 and 8, the separator 13 having the multilayer structure is used and accordingly, the polymer compound layer 13B is interposed between the porous layer 13A and the insulating tape 16. As described above, the porous layer 13A and the polymer compound layer 13B each constitute a portion of the separator 13 having the multilayer structure, and are thus integral with each other.

For easy viewing of the configuration of the insulating tape 16, FIG. 8 illustrates a state in which the insulating tape 16 is separated from the separator 13. In actuality, however, the positive electrode 11 and the negative electrode 12 are tightly wound with the separator 13 interposed therebetween at a winding core part of the battery device 10, which allows the insulating tape 16 to be in close contact with the separator 13.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging, lithium is inserted and extracted in an ionic state.

In a case of manufacturing the secondary battery, the positive electrode 11 and the negative electrode 12 are fabricated and the electrolytic solution is prepared, following which the secondary battery is fabricated using the positive electrode 11, the negative electrode 12, and the electrolytic solution, according to a procedure to be described below. In the following, where appropriate, reference will be made to illustrations of FIGS. 1 to 8 which have been already described.

First, the positive electrode active material is mixed with, for example, the positive electrode binder and the positive electrode conductor on an as-needed basis to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on the opposite sides of the positive electrode current collector 11A to thereby form the positive electrode active material layers 11B. In this case, an application range of the positive electrode mixture slurry is adjusted to allow the positive electrode active material layers 11B to be each formed on a portion of the positive electrode current collector 11A, as described above. Thereafter, the positive electrode active material layers 11B may be compression-molded by means of a machine such as a roll pressing machine. In this case, the positive electrode active material layers 11B may be heated. The positive electrode active material layers 11B may be compression-molded multiple times. The positive electrode active material layers 11B are thus formed on the respective opposite sides of the positive electrode current collector 11A. In this manner, the positive electrode 11 is fabricated.

In a case of fabricating the positive electrode 11, the positive electrode 11 is fabricated to include the exposed part 11Z at the end part of the positive electrode 11 on the inner side of the winding when the positive electrode 11 and the negative electrode 12 are each wound in a fabrication process of the wound body to be described later.

The negative electrode active material layers 12B are formed on the respective opposite sides of the negative electrode current collector 12A by a procedure similar to the fabrication procedure of the positive electrode 11 described above. Specifically, the negative electrode active material is mixed with, for example, the negative electrode binder and the negative electrode conductor on an as-needed basis to thereby obtain a negative electrode mixture, following which the negative electrode mixture is put into a solvent such as an organic solvent to thereby prepare a paste negative electrode mixture slurry. Thereafter, the negative electrode mixture slurry is applied on the opposite sides of the negative electrode current collector 12A to thereby form the negative electrode active material layers 12B. In this case, an application range of the negative electrode mixture slurry is adjusted to allow the negative electrode active material layers 12B to be each formed on a portion of the negative electrode current collector 12A, as described above. Thereafter, the negative electrode active material layers 12B may be compression-molded. The negative electrode active material layers 12B are thus formed on the respective opposite sides of the negative electrode current collector 12A. In this manner, the negative electrode 12 is fabricated.

The electrolyte salt is put into the solvent including the chain carboxylic acid ester. The electrolyte salt is thus dispersed or dissolved in the solvent. In this manner, the electrolytic solution is prepared.

First, the porous layer 13A having the opposed surfaces M1 and M2 is prepared. Thereafter, the polymer compound and the inorganic particles are put into a solvent such as an organic solvent to thereby prepare a paste slurry. Lastly, the slurry is applied on each of the two opposed surfaces (the opposed surfaces M1 and M2) of the porous layer 13A to thereby form the polymer compound layer 13B. The polymer compound layer 13B including the inorganic particles is thereby formed on each of the two opposed surfaces of the porous layer 13A. In this manner, the separator 13 having the multilayer structure is fabricated.

First, the positive electrode lead 14 is coupled to the end part of the positive electrode 11 (the positive electrode current collector 11A serving as the exposed part 11Z) by a method such as a welding method, and the negative electrode lead 15 is coupled to the end part of the negative electrode 12 (the negative electrode current collector 12A) by a method such as a welding method.

Thereafter, the insulating tape 16 is attached to the exposed part 11Z. In this case, the insulating tape 16 is adhered to the exposed part 11Z via the adhesive layer 16B including the rubber-based polymer compound to allow the positive electrode lead 14 coupled to the exposed part 11Z to be covered with the insulating tape 16.

Thereafter, the positive electrode 11 and the negative electrode 12 are stacked on each other with the separator 13 interposed therebetween, following which the stack of the positive electrode 11, the negative electrode 12, and the separator 13 is wound about the winding axis J in the winding direction D to thereby fabricate the wound body (not illustrated).

Thereafter, the wound body is pressed in the direction intersecting the winding axis J to thereby shape the wound body to have an elongated shape in a section intersecting the winding axis J. Thereafter, the fixing tapes 23 (23A to 23C) are attached to the wound body.

Thereafter, the wound body is placed inside the depression part 20U, following which the outer package film 20 is folded in the direction of the arrow R. Thereafter, outer edges of two sides of the outer package film 20 (the fusion-bonding layer) are bonded to each other by a method such as a thermal-fusion-bonding method. The wound body is thereby contained inside the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 14, and the sealing film 22 is interposed between the outer package film 20 and the negative electrode lead 15. The wound body is thereby impregnated with the electrolytic solution. Thus, the battery device 10 is fabricated. In this manner, the battery device 10 is sealed inside the pouch-shaped outer package film 20. The secondary battery is thus assembled.

The assembled secondary battery is charged and discharged. Various conditions including an environment temperature, the number of times of charging and discharging (the number of cycles), and charging and discharging conditions may be freely chosen. Through this process, a film is formed on a surface of, for example, the negative electrode 12, to thereby bring the secondary battery into an electrochemically stable state. The secondary battery including the outer package film 20, that is, the secondary battery of the laminated-film type, is thus completed.

According to the secondary battery, the electrolytic solution includes the chain carboxylic acid ester. Further, the insulating tape 16 includes the adhesive layer 16B including the rubber-based polymer compound. The insulating tape 16 is adhered to the exposed part 11Z of the positive electrode 11 via the adhesive layer 16B on the side opposed to the negative electrode active material layer 12B of the negative electrode 12. Accordingly, for reasons described below, it is possible to achieve a superior cyclability characteristic, a superior swelling characteristic, and superior safety.

As a secondary battery of a comparative example, conceivable is a secondary battery having a configuration similar to that of the secondary battery of the present embodiment except that the adhesive layer 16B of the insulating tape 16 includes a material other than the rubber-based polymer compound. Specific examples of the material other than the rubber-based polymer compound include an acrylic-based polymer compound. Also in a case where the adhesive layer 16B includes the other material such as the acrylic-based polymer compound, the adhesive layer 16B has adhesiveness and the insulating tape 16 is thus adherable to the exposed part 11Z via the adhesive layer 16B.

The “acrylic-based polymer compound” refers to a so-called acrylic-based adhesive, that is, an adhesive that results from synthesizing an acrylic polymer having a desired function by selecting and copolymerizing acrylic monomers. The acrylic-based polymer compound is an adhesive that includes the acrylic polymer as a base material. The acrylic-based polymer compound also includes an adhesive into which a crosslinking point has been introduced by addition of a crosslinking agent such as an isocyanate or an epoxy, and an adhesive into which a functional-group-containing monomer such as an acrylic acid or hydroxyethyl acrylate has been introduced.

According to the secondary battery of the comparative example, the adhesive layer 16B includes the acrylic-based polymer compound or the like in the case where the electrolytic solution includes the chain carboxylic acid ester, however. In this case, it becomes easier for the adhesive layer 16B to be swollen with the chain carboxylic acid ester, which makes it easier for the chain carboxylic acid ester to infiltrate into between the base material layer 16A and the exposed part 11Z. This causes the adhesive layer 16B to easily decrease in adhesive strength to the exposed part 11Z, thus causing the insulating tape 16 to easily peel away from the exposed part 11Z. The peeling of the insulating tape 16 described here includes partial peeling, entire peeling, or both.

For the above-described reasons, in the secondary battery of the comparative example, a region in which the positive electrode 11 (the positive electrode current collector 11A) and the negative electrode 12 (the negative electrode current collector 12A) are directly opposed to each other with the separator 13 interposed therebetween is easily formed due to the peeling of the insulating tape 16. In this case, if the separator 13 shrinks due to, for example, a thermal factor, a short circuit easily occurs between the positive electrode 11 and the negative electrode 12, resulting in decreased safety. Accordingly, it is difficult to achieve superior safety, and is also difficult to achieve a superior cyclability characteristic and a superior swelling characteristic.

In contrast, according to the secondary battery of the present embodiment, the adhesive layer 16B includes the rubber-based polymer compound in the case where the electrolytic solution includes the chain carboxylic acid ester. In this case, the adhesive layer 16B is prevented from being easily swollen with the chain carboxylic acid ester, and the chain carboxylic acid ester is thus prevented from easily infiltrating into between the base material layer 16A and the exposed part 11Z. This prevents the adhesive layer 16B from easily decreasing in adhesion strength to the exposed part 11Z, and thus prevents the insulating tape 16 from easily peeling away from the exposed part 11Z.

For the above-described reasons, according to the secondary battery of the present embodiment, it is easier to maintain a state of adhesion of the insulating tape 16 to the exposed part 11Z. This suppresses the occurrence of a short circuit between the positive electrode 11 and the negative electrode 12, thus resulting in improved safety. Accordingly, it is possible to achieve superior safety, and to also achieve a superior cyclability characteristic and a superior swelling characteristic.

More specifically, increasing the content of the chain carboxylic acid ester in the electrolytic solution improves the cyclability characteristic, but on the other hand, makes it easier for the insulating tape 16 (the adhesive layer 16B) to be swollen, thus causing the safety to tend to decrease. Further, increasing the amount (the thickness) of the adhesive layer 16B in the insulating tape 16 improves the safety by preventing the adhesive layer 16B from being easily swollen, but on the other hand, makes it easier for the adhesive layer 16B to react in part with the electrolytic solution, thus causing the cyclability characteristic and the swelling characteristic to tend to be degraded. However, according to the secondary battery of the present embodiment in which the adhesive layer 16B includes the rubber-based polymer compound, improved safety is achieved because the adhesive layer 16B is prevented from being easily swollen even if the content of the chain carboxylic acid ester in the electrolytic solution is increased. Furthermore, improvements in cyclability characteristic and swelling characteristic are achieved because the adhesive layer 16B is prevented from easily reacting in part with the electrolytic solution. Accordingly, it is possible to achieve a superior cyclability characteristic, a superior swelling characteristic, and superior safety.

The rubber-based polymer compound may include, for example, an isoprene rubber, in particular. This helps to sufficiently prevent the adhesive layer 16B from being easily swollen with the chain carboxylic acid ester. Accordingly, it is possible to achieve higher effects.

Further, the adhesion strength of the insulating tape 16 to the exposed part 11Z may be within the range from 1 mN/mm² to 15 mN/mm² both inclusive. This secures the adhesiveness of the insulating tape 16 to the exposed part 11Z. The insulating tape 16 is thus sufficiently prevented from easily peeling away from the exposed part 11Z. Accordingly, it is possible to achieve higher effects.

Further, the positive electrode 11 and the negative electrode 12 may be wound. This helps to sufficiently prevent the insulating tape 16 from easily peeling away even if the positive electrode 11 (the exposed part 11Z) is curved. In this case, the exposed part 11Z may be located at the end part of the positive electrode 11 on the inner side of the winding. This helps to effectively prevent a short circuit from easily occurring even at the winding core part of the battery device 10 (the wound electrode body) at which heat accumulates or builds up easily, and to also effectively suppress the precipitation of lithium. Accordingly, it is possible to achieve further higher effects.

Further, the battery device 10 may have an elongated shape in a section intersecting the winding axis J, and the fixing tape 23 may be fixed to each of the top surface 10M1 and the bottom surface 10M2 of the battery device 10 in the direction intersecting the major axis K1. This allows the three-dimensional shape (the shaped state) of the battery device 10 to be maintained by the fixing tape 23. The winding state of the positive electrode 11, the negative electrode 12, and the separator 13 is thus maintained to thereby suppress a thermal shrinkage of the separator 13. Accordingly, it is possible to achieve higher effects.

Further, the separator 13 having the multilayer structure may be used. This allows the porous layer 13A to be interposed between the positive electrode 11 and the negative electrode 12, and allows the polymer compound layer 13B including the inorganic particles to be interposed between the porous layer 13A and the insulating tape 16. In this case, mobility of lithium ions is secured by the porous layer 13A while heat resistance of the secondary battery is secured by the inorganic particles. This makes it possible for charging and discharging reactions to proceed smoothly and stably with safety secured. Accordingly, it is possible to achieve higher effects.

Further, the positive electrode lead 14 may be coupled to the exposed part 11Z and the insulating tape 16 may cover the positive electrode lead 14. This allows the state of coupling of the positive electrode lead 14 to the exposed part 11Z to be protected by the insulating tape 16. The positive electrode lead 14 is thus prevented from easily becoming detached from the positive electrode current collector 11A even if the secondary battery undergoes a shock upon falling, for example. Accordingly, it is possible to achieve higher effects.

Further, the flexible outer package film 20 may contain the insulating tape 16 together with the positive electrode 11, the negative electrode 12, and the electrolytic solution. This effectively suppresses the swelling of the secondary battery even in a case of using the outer package film 20 which is easily deformable due to a rise in internal pressure, that is, even in a case where the swelling of the secondary battery easily becomes apparent due to the flexibility of the outer package film 20. Accordingly, it is possible to achieve higher effects.

Further, the secondary battery may include a lithium-ion secondary battery. This makes it possible to obtain a sufficient battery capacity stably by using a lithium insertion phenomenon and a lithium extraction phenomenon. Accordingly, it is possible to achieve higher effects.

Next, a description is given of modifications of the secondary battery. The configuration of the secondary battery described above is appropriately modifiable, as will be described below. Note that any two or more of the following series of modifications may be combined.

In FIG. 8, the positive electrode current collector 11A (the exposed part 11Z) is opposed to the negative electrode 12 (the negative electrode active material layer 12B) with the separator 13 interposed therebetween, and the insulating tape 16 is adhered to the exposed part 11Z.

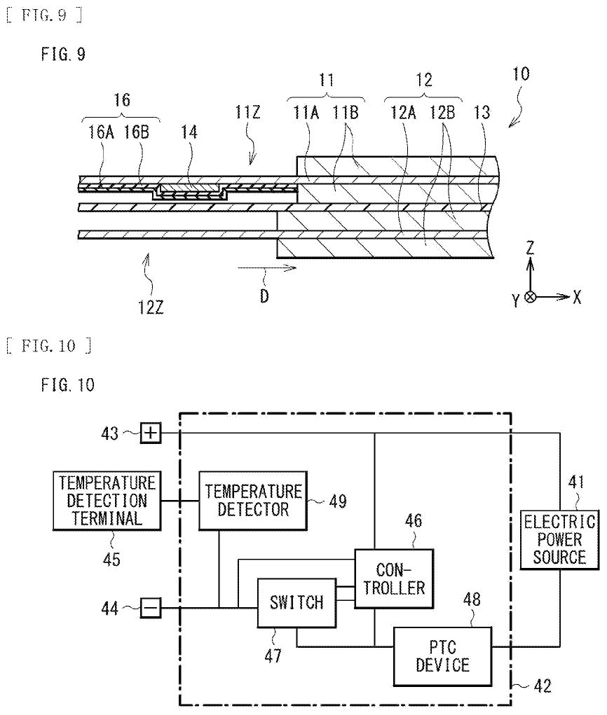

However, as illustrated in FIG. 9 corresponding to FIG. 8, the negative electrode 12 may include an exposed part 12Z. Thus, the positive electrode current collector 11A (the exposed part 11Z) may be opposed to the negative electrode 12 (the exposed part 12Z) with the separator 13 interposed therebetween, and the insulating tape 16 may be adhered to the exposed part 11Z. The exposed part 12Z is a portion in which the negative electrode current collector 12A is not covered with the negative electrode active material layer 12B and is thus exposed. In this case also, the occurrence of a short circuit between the positive electrode 11 and the negative electrode 12 is suppressed using the insulating tape 16. Accordingly, it is possible to achieve similar effects.

In FIG. 8, the exposed part 11Z is located at the end part of the positive electrode 11 on the inner side of the winding, and the insulating tape 16 is adhered to the exposed part 11Z. However, there is no particular limitation to the location of each of the exposed part 11Z and the insulating tape 16.

Specifically, the exposed part 11Z may be located at the end part of the positive electrode 11 on the outer side of the winding, and the insulating tape 16 may be adhered to the exposed part 11Z. Alternatively, the exposed parts 11Z may be located at respective end parts of the positive electrode 11 on the inner side of the winding and the outer side of the winding, and the insulating tape 16 may be adhered to each of the exposed parts 11Z. In such cases also, the insulating tape 16 is prevented from easily peeling away from the exposed part(s) 11Z. Accordingly, it is possible to achieve similar effects.

Note that in order to effectively prevent the occurrence of a short circuit also at the winding core part of the battery device 10 at which heat accumulates easily and to effectively prevent the precipitation of lithium, the exposed part 11Z is preferably located at the end part of the positive electrode 11 on the outer side of the winding, and the insulating tape 16 is preferably adhered to the exposed part 11Z, as described above.

In FIG. 8, the insulating tape 16 covers the positive electrode lead 14. However, the insulating tape 16 does not have to cover the positive electrode lead 14. More specifically, the insulating tape 16 may be adhered only to a region of the exposed part 11Z other than a region where the positive electrode lead 14 is provided. In such a case also, the insulating tape 16 is prevented from easily peeling away from the exposed part 11Z except in the region where the positive electrode lead 14 is provided. Accordingly, it is possible to achieve similar effects.

Note that in order to protect or maintain a state of adhesion of the positive electrode lead 14 to the exposed part 11Z by using the insulating tape 16, the insulating tape 16 preferably covers the positive electrode lead 14, as described above.

In FIGS. 2 and 3, the secondary battery includes the three fixing tapes 23 (23A, 23B, and 23C). However, the presence or absence, the number, and the locations of the fixing tapes 23 are not particularly limited, and may be freely chosen.

Specifically, the battery device 10 may be provided with no fixing tape 23. Alternatively, the number of the fixing tapes 23 provided on the battery device 10 may be one, two, or four or more. Note that in a case where the number of the fixing tapes 23 is two or more, it is preferable that one or more of the fixing tapes 23 be disposed on the side closer to the positive electrode lead 14 and the negative electrode lead 15, and the remaining one or more fixing tapes 23 be disposed on the side farther from the positive electrode lead 14 and the negative electrode lead 15. A reason for this is that such a layout makes it easier to maintain the three-dimensional shape (the shaped state) of the battery device 10 by using the fixing tapes 23. In such cases also, the insulating tape 16 is prevented from easily peeling away from the exposed part 11Z. Accordingly, it is possible to achieve similar effects.

Note that in order to maintain the three-dimensional shape of the battery device 10, the battery device 10 is preferably provided with the fixing tape(s) 23, as described above.

In FIG. 7, the separator 13 having the multilayer structure includes the porous layer 13A and the polymer compound layer 13B, and thus the porous layer 13A and the polymer compound layer 13B are integral with each other. However, the configuration of the separator 13 is not particularly limited as long as the porous layer 13A is interposed between the positive electrode 11 and the negative electrode 12 and the polymer compound layer 13B is interposed between the porous layer 13A and the insulating tape 16.

Specifically, the polymer compound layer 13B does not have to be provided on the porous layer 13A in advance, and may thus be provided separately from the porous layer 13A. In this case, the separator 13 is a single-layer separator 13 including the porous layer 13A, and the polymer compound layer 13B separate from the porous layer 13A is interposed between the single-layer separator 13 and the insulating tape 16.

Alternatively, the polymer compound layer 13B may be provided on the insulating tape 16 in advance, instead of being provided on the porous layer 13A in advance, and may thus be provided separately from the single-layer separator 13 (the porous layer 13A). In this case, the separator 13 is the single-layer separator 13 including the porous layer 13A, and the insulating tape 16 and the polymer compound layer 13B are integral with each other.

In such cases also, the porous layer 13A is interposed between the positive electrode 11 and the negative electrode 12, and the polymer compound layer 13B is interposed between the porous layer 13A and the insulating tape 16. Accordingly, it is possible to achieve similar effects.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are alternately stacked with the separator 13 and the electrolyte layer interposed therebetween. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. The configuration of the electrolytic solution is as described above. The polymer compound includes, for example, polyvinylidene difluoride. In a case of forming the electrolyte layer, a precursor solution is prepared that includes, for example, the electrolytic solution, the polymer compound, and an organic solvent, following which the precursor solution is applied on one of or each of opposite sides of the positive electrode 11 and one of or each of opposite sides of the negative electrode 12.

Also in the case where the electrolyte layer is used, similar effects are obtainable because lithium ions are movable between the positive electrode 11 and the negative electrode 12 via the electrolyte layer.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. Note that the secondary battery may have a battery structure of the above-described laminated-film type, a cylindrical type, or any other type. Further, multiple secondary batteries may be used, for example, as a battery pack or a battery module.

In particular, the battery pack and the battery module are each effectively applied to relatively large-sized equipment, etc., including an electric vehicle, an electric power storage system, and an electric power tool. The battery pack, as will be described later, may include a single battery, or may include an assembled battery. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

Some application examples of the secondary battery will now be described in detail. The configurations of the application examples described below are mere examples, and are appropriately modifiable.

FIG. 10 illustrates a block configuration of a battery pack. The battery pack described here is a simple battery pack (a so-called soft pack) including one secondary battery, and is to be mounted on, for example, electronic equipment typified by a smartphone.

As illustrated in FIG. 10, the battery pack includes an electric power source 41 and a circuit board 42. The circuit board 42 is coupled to the electric power source 41, and includes a positive electrode terminal 43, a negative electrode terminal 44, and a temperature detection terminal 45. The temperature detection terminal 45 is a so-called T terminal.

The electric power source 41 includes one secondary battery. The secondary battery has a positive electrode lead coupled to the positive electrode terminal 43 and a negative electrode lead coupled to the negative electrode terminal 44. The electric power source 41 is couplable to outside via the positive electrode terminal 43 and the negative electrode terminal 44, and is thus chargeable and dischargeable via the positive electrode terminal 43 and the negative electrode terminal 44. The circuit board 42 includes a controller 46, a switch 47, a thermosensitive resistive device (a positive temperature coefficient (PTC) device) 48, and a temperature detector 49. However, the PTC device 48 may be omitted.

The controller 46 includes, for example, a central processing unit (CPU) and a memory, and controls an overall operation of the battery pack. The controller 46 detects and controls a use state of the electric power source 41 on an as-needed basis.

If a battery voltage of the electric power source 41 (the secondary battery) reaches an overcharge detection voltage or an overdischarge detection voltage, the controller 46 turns off the switch 47. This prevents a charging current from flowing into a current path of the electric power source 41. In addition, if a large current flows upon charging or discharging, the controller 46 turns off the switch 47 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 47 includes, for example, a charge control switch, a discharge control switch, a charging diode, and a discharging diode. The switch 47 performs switching between coupling and decoupling between the electric power source 41 and external equipment in accordance with an instruction from the controller 46. The switch 47 includes, for example, a metal-oxide-semiconductor field-effect transistor (MOSFET) including a metal-oxide semiconductor. The charging and discharging currents are detected on the basis of an ON-resistance of the switch 47.

The temperature detector 49 includes a temperature detection device such as a thermistor. The temperature detector 49 measures a temperature of the electric power source 41 using the temperature detection terminal 45, and outputs a result of the temperature measurement to the controller 46. The result of the temperature measurement to be obtained by the temperature detector 49 is used, for example, in a case where the controller 46 performs charge/discharge control upon abnormal heat generation or in a case where the controller 46 performs a correction process upon calculating a remaining capacity.

### EXAMPLES

A description will be given of Examples of the present technology according to an embodiment.

### Experiment Examples 1-1 to 1-11

As described below, secondary batteries (lithium-ion secondary batteries) of the laminated-film type illustrated in FIGS. 1 to 8 were fabricated, following which the secondary batteries were evaluated for their cyclability characteristics, swelling characteristics, and safety.

### [Fabrication of Secondary Battery]

The secondary batteries were fabricated in accordance with the following procedure.

### (Fabrication of Positive Electrode)

First, 96 parts by mass of the positive electrode active material (lithium cobalt oxide (LiCoO₂)), 3 parts by mass of the positive electrode binder (polyvinylidene difluoride), and 1 part by mass of the positive electrode conductor (carbon black) were mixed together to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on the opposite sides of the positive electrode current collector 11A (an aluminum foil, 12 μm in thickness) by means of a coating apparatus, following which the applied positive electrode mixture slurry was dried to thereby form the positive electrode active material layers 11B. In this case, the positive electrode current collector 11A was exposed in part by adjusting the application range of the positive electrode mixture slurry in such a manner as not to form the positive electrode active material layers 11B on each of opposite end parts of the positive electrode current collector 11A. Lastly, the positive electrode active material layers 11B were compression-molded by means of a roll pressing machine. In this manner, the positive electrode active material layers 11B were formed on the respective opposite sides of the positive electrode current collector 11A. The positive electrode 11 including the exposed parts 11Z was thus fabricated.

### (Fabrication of Negative Electrode)

First, 97 parts by mass of the negative electrode active material (graphite, 15 μm in median diameter D50), 1.5 parts by mass of the negative electrode binder (an acrylic-acid-modified styrene-butadiene rubber copolymer), and 1.5 parts by mass of a thickener (carboxymethyl cellulose) were mixed together to thereby obtain a negative electrode mixture. Thereafter, the negative electrode mixture was put into an aqueous solvent (pure water), following which the organic solvent was stirred to thereby prepare a paste negative electrode mixture slurry. Thereafter, the negative electrode mixture slurry was applied on the opposite sides of the negative electrode current collector 12A (a copper foil, 15 μm in thickness) by means of a coating apparatus, following which the applied negative electrode mixture slurry was dried to thereby form the negative electrode active material layers 12B. In this case, the negative electrode mixture slurry thus applied was heat-treated at a temperature of 200° C. Further, the negative electrode current collector 12A was exposed in part by adjusting the application range of the negative electrode mixture slurry in such a manner as not to form the negative electrode active material layers 12B on each of opposite end parts of the negative electrode current collector 12A. Lastly, the negative electrode active material layers 12B were compression-molded by means of a roll pressing machine. In this manner, the negative electrode active material layers 12B were formed on the respective opposite sides of the negative electrode current collector 12A. The negative electrode 12 was thus fabricated.

### (Preparation of Electrolytic Solution)

The electrolyte salt (lithium hexafluorophosphate (LiPF₆)) was added to the solvent (a mixture of ethylene carbonate which is a cyclic carbonic acid ester and propyl propionate (PP) which is a chain carboxylic acid ester), following which the solvent was stirred. The content (wt %) of the chain carboxylic acid ester in the solvent was as listed in Table 1. The content of the electrolyte salt with respect to the solvent was set to 1 mol/kg. The electrolyte salt was thereby dissolved in the solvent. In this manner, the electrolytic solution was prepared.

For comparison, the electrolytic solution was prepared by a similar procedure except that the chain carboxylic acid ester was not used.

### (Preparation of Separator)

Here, the separator 13 having the multilayer structure was used. In a case of fabricating the separator 13 having the multilayer structure, first, the polymer compound (polyvinylidene difluoride) and the inorganic particles (aluminum oxide, 0.3 μm in median diameter D50) were put into an organic solvent (N-methyl-2-pyrrolidone), following which the organic solvent was stirred to thereby prepare a dispersion liquid. In this case, a mixture ratio (a weight ratio) between the polymer compound and the inorganic particles was set to 20:80. Thereafter, the porous layer 13A (a fine porous polyethylene film, 12 μm in thickness) was immersed in the dispersion liquid. Thereafter, the porous layer 13A was taken out of the dispersion liquid, following which the porous layer 13A was washed with an aqueous solvent (pure water) to thereby remove the organic solvent. Lastly, the porous layer 13A was dried with hot air having a temperature of 80° C. Thus, the polymer compound layers 13B (5 μm in total thickness) each including the polymer compound and the inorganic particles were formed on the respective opposed surfaces of the porous layer 13A. In this manner, the separator 13 having the multilayer structure was fabricated.

For comparison, the separator 13 having a single-layer structure (a fine porous polyethylene film, 15 μm in thickness) was also used instead of the separator 13 having the multilayer structure.

### (Assembly of Secondary Battery)

First, the positive electrode lead 14 (an aluminum foil) was welded to the end part of the positive electrode 11 (the positive electrode current collector 11A serving as the exposed part 11Z), and the negative electrode lead 15 (a copper foil) was welded to the end part of the negative electrode 12 (the negative electrode current collector 12A).

Thereafter, the insulating tape 16 was attached to the exposed part 11Z to cover the positive electrode lead 14. As the insulating tape 16, an adhesive tape including the base material layer 16A (PET, 10 μm in thickness) and the adhesive layer 16B stacked on each other was used. The insulating tape 16 was thus adhered to the exposed part 11Z via the adhesive layer 16B. A constituent material (the kind of the polymer compound) and the thickness (μm) of the adhesive layer 16B were as listed in Table 1. Here, a styrene-butadiene rubber was used as the rubber-based polymer compound.

For comparison, the insulating tape 16 having a similar configuration except that the adhesive layer 16B included the acrylic-based polymer compound instead of the rubber-based polymer compound was also used. Here, a polymer compound including an acrylic acid alkyl ester as a main component was used as the acrylic-based polymer compound.

Thereafter, the positive electrode 11 and the negative electrode 12 were stacked on each other with the separator 13 having the multilayer structure interposed therebetween, following which the stack of the positive electrode 11, the negative electrode 12, and the separator 13 was wound about the winding axis J in the winding direction D to thereby fabricate the wound body. Thereafter, the wound body was pressed at a pressing pressure of 1 N/cm² in the direction intersecting the winding axis J to thereby shape the wound body to have an elongated sectional shape. Thereafter, the three fixing tapes 23A to 23C, each being a polyethylene tape having a thickness of 30 μm, were attached to the wound body.

For comparison, the wound body was shaped by a similar procedure except that none of the fixing tapes 23A to 23C was attached to the wound body.

Thereafter, the outer package film 20 was folded in such a manner as to sandwich the wound body placed inside the depression part 20U, following which the outer edges of two sides of the outer package film 20 were thermal-fusion-bonded to each other to thereby allow the wound body to be contained inside the pouch-shaped outer package film 20. As the outer package film 20, an aluminum laminated film was used in which a fusion-bonding layer (a polypropylene film, 30 μm in thickness), a metal layer (an aluminum foil, 40 μm in thickness), and a surface protective layer (a nylon film, 25 μm in thickness) were stacked in this order from the inner side.

Lastly, the electrolytic solution was injected into the pouch-shaped outer package film 20 and thereafter, the outer edges of the remaining one side of the outer package film 20 were thermal-fusion-bonded to each other in a reduced-pressure environment. In this case, the sealing film 21 (a polypropylene film, 5 μm in thickness) was interposed between the outer package film 20 and the positive electrode lead 14, and the sealing film 22 (a polypropylene film, 5 μm in thickness) was interposed between the outer package film 20 and the negative electrode lead 15. Thereafter, the outer package film 20 into which the electrolytic solution had been injected was left standing for 48 hours. The stacked body was thereby impregnated with the electrolytic solution. Thus, the battery device 10 was formed. In this manner, the battery device 10 was sealed inside the outer package film 20. The secondary battery was thus assembled.

### (Stabilization of Secondary Battery)

In an ambient temperature environment (at a temperature of 23° C.), the secondary battery after heated at a temperature of 60° C. was charged and discharged for two cycles while being pressed with a pressing machine at a pressing pressure of 20 kgf/cm² in a direction similar to the direction of pressing of the wound body.

Upon the charging, the secondary battery was charged with a constant current of 0.1 C until a battery voltage reached 4.45 V, and was thereafter charged with a constant voltage of 4.45 V until a current reached 0.05 C. Upon the discharging, the secondary battery was discharged with a constant current of 0.1 C until the battery voltage reached 3.0 V. Note that 0.1 C is a value of a current that causes a battery capacity (a theoretical capacity) to be completely discharged in 10 hours, and 0.05 C is a value of a current that causes the battery capacity to be completely discharged in 20 hours.

As a result, a film was formed on the surface of, for example, the negative electrode 12 to stabilize the state of the secondary battery. Thus, the secondary battery of the laminated-film type was completed.

Evaluations of the secondary batteries for their cyclability characteristics, swelling characteristics, and safety revealed the results presented in Table 1.

In a case of examining the cyclability characteristic, first, the secondary battery was charged and discharged in an ambient temperature environment (at a temperature of 23° C.) to thereby measure a discharge capacity (a first-cycle discharge capacity). Thereafter, the secondary battery was repeatedly charged and discharged in the same environment until the total number of cycles reached 500, and the discharge capacity (a 500th-cycle discharge capacity) was measured. Lastly, the following was calculated: capacity retention rate (%)=(500th-cycle discharge capacity/first-cycle discharge capacity)×100.

Charging and discharging conditions were similar to those in the case of stabilizing the state of the secondary battery described above, except that the current at the time of charging was changed from 0.1 C to 2 C, and the current at the time of discharging was changed from 0.1 C to 0.5 C. Note that 2 C is a value of a current that causes the battery capacity to be completely discharged in 0.5 hours, and 0.5 C is a value of a current that causes the battery capacity to be completely discharged in 2 hours.

In a case of examining the swelling characteristic, first, the secondary battery was charged in an ambient temperature environment (at a temperature of 23° C.), following which a thickness (a pre-storage thickness) of the secondary battery was measured. Charging conditions were similar to those in the case of examining the cyclability characteristic described above. Thereafter, the secondary battery in the charged state was stored for a storing period of 1 month in a high-temperature environment (at a temperature of 60° C.), following which the thickness (a post-storage thickness) of the secondary battery was measured. Lastly, the following was calculated: swelling rate (%)=[(post-storage thickness−pre-storage thickness)/pre-storage thickness]×100.

In a case of examining the safety, a heating safety test was performed on the secondary battery. Specifically, first, the secondary battery was charged in an ambient temperature environment (at a temperature of 23° C.). Charging conditions were similar to those in the case of examining the cyclability characteristic described above. Thereafter, the secondary battery in the charged state was placed in a thermostatic chamber, following which an internal temperature of the thermostatic chamber (an atmospheric temperature) was raised at a raising rate of 5° C./min to thereby heat the secondary battery. In this case, after the atmospheric temperature reached 130° C., a state at the atmospheric temperature was kept for 1 hour. Further, in the process of heating, a voltage of the secondary battery was measured to examine a behavior of the voltage. Lastly, a post-heating state of the secondary battery was determined on the basis of the behavior of the voltage. Specifically, in a case where the voltage did not abruptly drop, it was determined that no internal short circuit occurred, and this case was thus determined as “A”. In contrast, in a case where the voltage abruptly dropped to approximately 2.0 V, it was determined that an internal short circuit occurred, and this case was thus determined as “C”.

After examining the post-heating state of the secondary battery, the secondary battery was disassembled to visually examine a state of the separator 13 and to measure a peel strength (mN/mm²) of the insulating tape 16. The method of measuring the peel strength of the insulating tape 16 was as described above.

In a case where a thermal shrinkage of the separator 13 was noted as a result of examining the state of the separator 13, a shrinkage amount (mm) of the separator 13 was measured. The shrinkage amount is an amount (a distance) by which a position (a post-thermal-shrinkage position) of an outer edge of the separator 13 has moved inwardly from an original position (a pre-thermal-shrinkage position). Note that the shrinkage amount was not measurable (unmeasurable) in a case where the separator 13 had shrunk significantly.

TABLE 1

| | Electrolytic | | | | | | | | | | |
|---|---|---|---|---|---|---|---|---|---|---|---|
| | Solution | | | | | | | | | | |
| | Chain | | Insulating tape | | | | | | | | |
| | carb- | | | | Adhesion | | Separator | | | | Capacity |
| | oxylic | | | Thick- | strength | | | Shrinkage | | Swelling | retention |
| Experiment | acid | Content | Polymer | ness | (mN/ | Fixing | | amount | Short | rate | rate |
| example | ester | (wt %) | compound | (μm) | mm²) | tape | Configuration | (mm) | circuit | (%) | (%) |
| 1-1 | PP | 0 | Rubber- | 13 | 20.0 | No | Multilayer | 0 | No | 1.8 | 60 |
| | | | based | | | | structure | | | | |
| 1-2 | PP | 10 | Rubber- | 13 | 15.2 | No | Multilayer | 1.5 | No | 2.9 | 70 |
| | | | based | | | | structure | | | | |
| 1-3 | PP | 20 | Rubber- | 13 | 14.0 | No | Multilayer | 2.3 | No | 3.1 | 78 |
| | | | based | | | | structure | | | | |
| 1-4 | PP | 30 | Rubber- | 13 | 11.0 | No | Multilayer | 2.5 | No | 4.2 | 80 |
| | | | based | | | | structure | | | | |
| 1-5 | PP | 40 | Rubber- | 13 | 9.2 | No | Multilayer | 2.7 | No | 4.5 | 85 |
| | | | based | | | | structure | | | | |
| 1-6 | PP | 50 | Rubber- | 13 | 7.8 | No | Multilayer | 2.9 | No | 4.6 | 88 |
| | | | based | | | | structure | | | | |
| 1-7 | PP | 60 | Rubber- | 13 | 2.6 | No | Multilayer | 3.2 | No | 4.7 | 87 |
| | | | based | | | | structure | | | | |
| 1-8 | PP | 70 | Rubber- | 13 | 0.8 | No | Multilayer | 3.8 | No | 7.9 | 72 |
| | | | based | | | | structure | | | | |
| 1-9 | PP | 40 | Rubber- | 13 | 9.2 | Yes | Multilayer | 2.3 | No | 4.9 | 85 |
| | | | based | | | | structure | | | | |
| 1-10 | PP | 40 | Rubber- | 13 | 9.2 | No | Single-layer | 3.6 | No | 4.5 | 85 |
| | | | based | | | | structure | | | | |
| 1-11 | PP | 40 | Acrylic- | 13 | 4.4 | No | Multilayer | 4.8 | Yes | 8.8 | 85 |
| | | | based | | | | structure | | | | |

As indicated in Table 1, the cyclability characteristic, the swelling characteristic, and the safety of the secondary battery greatly varied depending on the composition of the electrolytic solution and the configuration of the insulating tape 16.

Specifically, in a case where the electrolytic solution included the chain carboxylic acid ester and the adhesive layer 16B of the insulating tape 16 included the acrylic-based polymer compound (Experiment example 1-11), a short circuit occurred. Further, in a case where the electrolytic solution did not include the chain carboxylic acid ester and the adhesive layer 16B of the insulating tape 16 included the rubber-based polymer compound (Experiment example 1-1), the capacity retention rate significantly decreased although no short circuit occurred.

In contrast, in a case where the electrolytic solution included the chain carboxylic acid ester and the adhesive layer 16B of the insulating tape 16 included the rubber-based polymer compound (Experiment examples 1-2 to 1-10), no short circuit occurred and a high capacity retention rate was achieved together with a low swelling rate.

In this case, the following tendencies were obtained, in particular. Firstly, the capacity retention rate further increased if the content of the chain carboxylic acid ester in the solvent was within the range from 20 wt % to 60 wt % both inclusive. Secondly, the separator 13 became more resistant to thermal shrinkage if the fixing tapes 23A to 23C were attached to the battery device 10. Thirdly, if the separator 13 having the multilayer structure was used, the separator 13 became more resistant to thermal shrinkage than in a case of using the separator 13 having the single-layer structure.

### Experiment Examples 2-1 to 2-7

As described in Table 2, secondary batteries were fabricated by a similar procedure except that the adhesion strength of the insulating tape 16 was changed, and the secondary batteries were evaluated for their cyclability characteristics, swelling characteristics, and safety. To change the adhesion strength of the insulating tape 16, the thickness of the insulating tape 16 was changed.

TABLE 2

| | Electrolytic | | | | | | | | | | |
|---|---|---|---|---|---|---|---|---|---|---|---|
| | solution | | Insulating tape | | | | Separator | | | | Capacity |
| | Chain | | | Thick- | Adhesion | | | Shrinkage | | Swelling | retention |
| Experiment | carboxylic | Content | Polymer | ness | strength | Fixing | | amount | Short | rate | rate |
| example | acid ester | (wt %) | compound | (μm) | (mN/mm²) | tape | Configuration | (mm) | circuit | (%) | (%) |
| 2-1 | PP | 40 | Rubber- | 21 | 15.2 | No | Multilayer | 2.1 | No | 12 | 86 |
| | | | based | | | | structure | | | | |
| 2-2 | PP | 40 | Rubber- | 18 | 15.1 | No | Multilayer | 2.3 | No | 10 | 85 |
| | | | based | | | | structure | | | | |
| 2-3 | PP | 40 | Rubber- | 16 | 15.0 | No | Multilayer | 2.9 | No | 2 | 85 |
| | | | based | | | | structure | | | | |
| 2-4 | PP | 40 | Rubber- | 14 | 12.5 | No | Multilayer | 3.2 | No | 1 | 85 |
| | | | based | | | | structure | | | | |
| 1-5 | PP | 40 | Rubber- | 13 | 9.2 | No | Multilayer | 2.7 | No | 4.5 | 85 |
| | | | based | | | | structure | | | | |
| 2-5 | PP | 40 | Rubber- | 11 | 1.3 | No | Multilayer | 4.2 | No | 0 | 84 |
| | | | based | | | | structure | | | | |
| 2-6 | PP | 40 | Rubber- | 10 | 1.0 | No | Multilayer | 4.3 | No | 0 | 83 |
| | | | based | | | | structure | | | | |
| 2-7 | PP | 40 | Rubber- | 8 | 0.8 | No | Multilayer | 5.2 | No | 0 | 82 |
| | | | based | | | | structure | | | | |

In the case where the electrolytic solution included the chain carboxylic acid ester and the adhesive layer 16B of the insulating tape 16 included the rubber-based polymer compound (Experiment examples 2-1 to 2-7), the swelling rate further decreased while the capacity retention rate was kept high if the adhesion strength of the insulating tape 16 was within the range from 1 mN/mm² to 15 mN/mm² both inclusive.

The results presented in Tables 1 and 2 indicate that if the electrolytic solution included the chain carboxylic acid ester, the insulating tape 16 included the adhesive layer 16B including the rubber-based polymer compound, and the insulating tape 16 was adhered to the exposed part 11Z of the positive electrode 11 via the adhesive layer 16B on the side opposed to the negative electrode 12, the occurrence of a short circuit was prevented and a high capacity retention rate was achieved together with a low swelling rate. Accordingly, a superior cyclability characteristic, a superior swelling characteristic, and superior safety were achieved by the secondary battery.

Although the present technology has been described herein, the configuration of the present technology is not limited thereto, and is therefore modifiable in a variety of suitable ways.

For example, although the description has been given of the case where the secondary battery has a battery structure of the laminated-film type, the battery structure is not particularly limited. Other examples of the battery structure employable include a cylindrical type, a prismatic type, a coin type, and a button type.

Further, although the description has been given of the case where the battery device has a device structure of the wound type, the device structure of the battery device is not particularly limited. Other examples of the device structure employable include a stacked type in which the electrodes (the positive electrode and the negative electrode) are stacked, and a zigzag folded type in which the electrodes (the positive electrode and the negative electrode) are folded in a zigzag manner.

Further, although the description has been given of the case where the electrode reactant is lithium, the electrode reactant is not particularly limited. Specifically, as described above, the electrode reactant may be another alkali metal such as sodium or potassium, or may be an alkaline earth metal such as beryllium, magnesium, or calcium. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the presently preferred embodiment described herein will be apparent to those skilled in the art. Such changes and modifications can be made without departing from the spirit and scope of the present subject matter without diminishing its intended advantages. It is therefore intended that such changes and modifications be covered by the appended claims.

1. A secondary battery comprising:
a positive electrode including a positive electrode current collector and a positive electrode active material layer;
a negative electrode opposed to the positive electrode;
an electrolytic solution including a chain carboxylic acid ester; and
an insulating member including an adhesive layer that includes a rubber-based polymer compound, wherein
the positive electrode includes an exposed part in which the positive electrode current collector is exposed, and
the insulating member is adhered to the exposed part via the adhesive layer on a side opposed to the negative electrode.

2. The secondary battery according to claim 1, wherein the rubber-based polymer compound includes at least one of an isoprene rubber, a butadiene rubber, a styrene-butadiene rubber, a chloroprene rubber, a nitrile rubber, a polyisobutylene rubber, chlorosulfonated polyethylene, an acrylic rubber, a fluorine rubber, an epichlorohydrin rubber, a urethane rubber, or a silicone rubber.

3. The secondary battery according to claim 1, wherein an adhesion strength of the insulating member to the exposed part is greater than or equal to one millinewton per square millimeter and smaller than or equal to 15 millinewtons per square millimeter.

4. The secondary battery according to claim 1, wherein
the electrolytic solution includes a solvent including the chain carboxylic acid ester, and
a content of the chain carboxylic acid ester in the solvent is greater than or equal to 20 weight percent and smaller than or equal to 60 weight percent.

5. The secondary battery according to claim 1, wherein the negative electrode and the positive electrode are wound.

6. The secondary battery according to claim 5, wherein the exposed part is located at an end part of the positive electrode on an inner side of winding.

7. The secondary battery according to claim 5, wherein
a battery device is formed by the negative electrode and the positive electrode being wound about a winding axis,
the battery device has an elongated shape defined by a major axis and a minor axis in a section intersecting the winding axis, and
the secondary battery further comprises a fixing member extending from one end part to another end part of the battery device in a direction intersecting the major axis, the fixing member being fixed to each of the one end part and the other end part.

8. The secondary battery according to claim 1, further comprising:
a porous layer interposed between the negative electrode and the positive electrode; and
a polymer compound layer interposed between the porous layer and the insulating member and including inorganic particles.

9. The secondary battery according to claim 1, further comprising a positive electrode terminal coupled to the exposed part, wherein
the insulating member covers the positive electrode terminal.

10. The secondary battery according to claim 1, further comprising a flexible outer package member containing the negative electrode, the positive electrode, the insulating member, and the electrolytic solution.

11. The secondary battery according to claim 1, wherein the secondary battery comprises a lithium-ion secondary battery.
